(19) United States
(12) Patent Application Publication
(10) Pub. No.: US 2007/0075093 A1
(43) Pub. Date: Apr. 5, 2007

(54) Liquid dispensing arrangements

(76) Inventor: R. Craig Thomasmeyer, Butler, PA (US)

Correspondence Address: FERENCE & ASSOCIATES, 409 BROAD STREET, PITTSBURGH, PA, 15143, US

(21) Appl. No.: 11/241,689

(22) Filed: Sep. 30, 2005

(51) Int. Cl. B67D 5/38

(52) U.S. Cl. 222/159; 222/158

(57) ABSTRACT

An apparatus for a gravity flow device for delivering a measured viscous fluid or liquid is disclosed, along with method of dispensing such fluid, is disclosed. Translucent tubing is preferably utilized to permit visualization of liquid disposed therewithin and the tubing includes at least one marking for facilitating measurement of liquid within said tubing.

### FIELD OF THE INVENTION

The present invention relates generally to dispensing and measuring media and, in particular, to a gravity flow device for delivering a measured viscous fluid or liquid.

### BACKGROUND OF THE INVENTION

Since time immemorial, efforts have been made to devise media for dispensing or providing measured quantities of different substances, such as any of a wide variety of viscous liquids, with increasing accuracy and efficiency. In a variety of settings, accurate and efficient dispensing and measurement can be of great importance.

One such setting is in the sphere of laundry detergent. As consumers increasingly make use of liquid, as opposed to powdered, laundry detergent, it becomes ever more apparent that conventional arrangements for dispensing or providing measured quantities of such detergent are often messy, cumbersome and not fully accurate. Typically, a consumer will need to pour out a “capful”, or a portion or multiple of a “capful” of liquid detergent into the plastic container cap itself and then pour this quantity into the washer. Accuracy is often compromised because of difficulty in seeing or discerning marks within the cap that help determine an appropriate measured quantity. Annoyingly, there will also often be a residual amount of liquid detergent remaining in the cap even once the bulk of it has been poured into the washer, with the result that, during or after replacement of the cap on the main container body, such residue will often taint a consumer's hand or ooze out onto the outer surface of the main container body.

Another disadvantage often encountered is that containers are often limited in size, meaning that consumers must purchase several smaller containers at once or return to a store with some frequency in order to ensure a steady supply of liquid detergent. There have clearly been practical limitations on the size of a container in connection with the ability of an average consumer to lift a container and pour liquid from it, especially into a cap. Any larger containers that do exist tend to be shunned by consumers largely because of these difficulties in handling them.

Some efforts have been made on occasion to attempt to redress shortcomings and disadvantages such as those just discussed, but continual room for improvement still exists. Accordingly, a need continues to be recognized in connection with providing arrangements that effect such needed improvement.

### SUMMARY OF THE INVENTION

There is broadly contemplated herein, in accordance with at least one presently preferred embodiment of the present invention, an arrangement for dispensing measured quantities of viscous liquid wherein containers with larger quantities can be feasibly obtained and made use of while ensuring a hitherto unsurpassed degree of accuracy and convenience in measurement. In accordance with at least one embodiment, a larger container may be equipped with a transparent (or at least translucent) tube that can extend from a bottom portion of the container. Such a tube can preferably have markings for displaying different measurable quantities of liquid. An end opening of the tube can preferably be selectively opened and closed with ease, to permit the convenient throughflow of measured quantities of liquid, while gravity ensures an ease of dispensing that does not require any inconvenient lifting.

In summary, one aspect of the invention provides an apparatus for dispensing liquid, said apparatus comprising: a tubing unit integrable with a container of liquid; said tubing unit comprising: a connection arrangement for connecting with a container of liquid; tubing extending from said connection arrangement; and a spigot arrangement disposed at an end of said tubing; said tubing being at least sufficiently translucent as to permit visualization of liquid disposed therewithin; said tubing comprising at least one marking for facilitating measurement of liquid within said tubing.

Another aspect of the invention provides a method for dispensing liquid, said method comprising the steps of: providing a tubing unit which extends from a connection region at a container of liquid; said step of providing a tubing unit comprising providing tubing and a spigot arrangement disposed at an end of the tubing, the tubing being at least sufficiently translucent as to permit visualization of liquid disposed therewithin and comprising at least one marking for facilitating measurement of liquid within said tubing; trapping a measureable quantity of liquid between the connection region and the spigot arrangement in the tubing; and thereafter dispensing liquid from the spigot arrangement.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 illustrates a container and tubing unit.

FIG. 2 is a frontal view of a valve connection from the container and tubing unit of FIG. 1.

### DESCRIPTION OF THE PREFERRED EMBODIMENTS

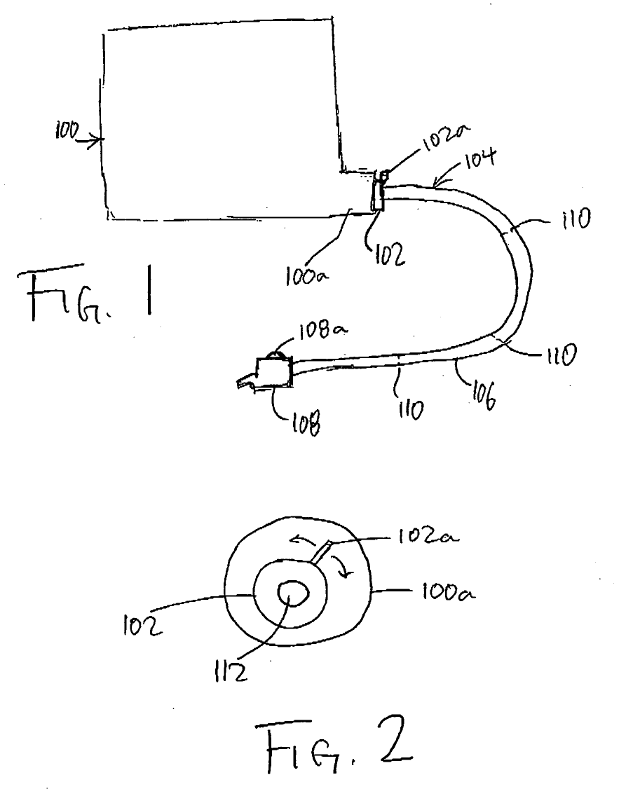

FIG. 1 illustrates, in accordance with an embodiment of the present invention, a container 100 configured for containing therewithin a viscous liquid such as laundry detergent. Container 100 may be of any suitable size, but it should be appreciated that in view of inventive features discussed herethroughout, container 100 may be considerably larger than conventionally sized pour-top containers (or bottles) that are normally used for containing liquid laundry detergent.

Preferably disposed at a lower portion of container 100 (i.e., at a portion towards which gravity can normally direct the contained fluid if the container 100 is oriented as shown in FIG. 1) is a sleeve portion 100a which may preferably engage with a tubing unit 104 that includes a valve connection 102. Though a wide variety of connection schemes are conceivable, valve connection 102 could be connected with sleeve portion 100a, e.g., via external threading on the former and internal threading on the latter. The tubing unit 104 further includes a length of flexible tubing 106, at the end of which is a spigot or other suitable opening/closing device 108 (i.e., a device preferably configured for selectably permitting and shutting off the throughflow of fluid). Preferably, the tubing unit 104 comprising valve connection 102, tubing 106 and spigot 108 is selectively attachable and detachable as a unit from container 100. In an alternative configuration, the tubing unit 106 could be fully integral with container 100.

Preferably, tubing 106 is transparent, or at least sufficiently translucent as to adequately convey, upon visual inspection, as to whether there is liquid contained within tubing 106 and where such liquid is disposed. Preferably etched or otherwise marked into or upon the outer surface of tubing 106 are graduated measurement markings 110 which indicate quantities of fluid contained within the tubing, assuming that spigot 106 is in a “closed” or “shut off” position and liquid within the tubing extends “backwards” towards valve connection 102 (e.g., when spigot 106 is elevationally lower then valve connection 102 and liquid has gravitated towards, and “rests” behind, spigot 106). Accordingly, markings 110 may preferably convey quantities of fluid that are of practical benefit to the application at hand. In the case of laundry detergent, for example, the markings could convey, e.g., ½ cup, 1 cup and 1½ cups. A marking could also convey the quantity of fluid that would be contained in the entire length of the tubing 106 (e.g, 2 cups), or such a maximum amount need not necessarily be marked but could be known to the consumer or user ahead of time. Of course, a wide variety of units and markings are conceivable and the arrangement illustrated in FIG. 1 provides but an illustrative and non-restrictive example; for instance, in countries using the metric system, metric-based markings could be provided. Conceivably, metric markings could even be intermingled with English system markings.

Spigot 108 may preferably include a button 108a or other arrangement that conveniently actuates throughput of liquid through spigot 108. Of course, a wide variety of other arrangements are conceivable that may easily be employed to provide an analogous function.

Preferably, there is an arrangement 102a for actuating or shutting off liquid throughput at valve connection 102. Though a wide variety of arrangements are conceivable for this purpose, illustrated in FIG. 1., and in a frontal view in FIG. 2, is a rotatable actuator 102a that may be actuated in either of the two circumferential directions indicated by arrows (i.e., clockwise or counterclockwise) to actuate or shut off liquid throughput through opening 112 (from where tubing 106 may extend).

In accordance with an embodiment of the present invention, when it is desired to dispense a measured quantity of liquid from container 100, it is first preferably ensured that spigot 108 is closed. Next, valve connection 102 may preferably be opened via actuator 102a to permit the initial outflow of liquid from container 100. Preferably, actuator 102a may have a sliding proportional effect such that different degrees of actuation will result in different degrees of throughput of liquid through opening 112; thus, liquid could progress through tubing 106 as slowly or as quickly as one may desire. When a desired quantity of liquid has propagated through tubing 106 (as discernible via markings 110), then valve connection 102 is preferably closed via actuator 102a. There will thus be a measured quantity of liquid in tubing 106 that is “trapped” between valve connection 102 and spigot 108. Thence, via spigot 108, the measured quantity of liquid may be dispensed to its intended destination (e.g., directly into a washing machine or into a cup or other container). It will be appreciated that throughout this process, most preferably, container 100 will be disposed at a generally higher elevation than spigot 108 so that the propagation of liquid into and through tubing 106, and out from spigot 108, will be aided by gravity.

A wide variety of applications are conceivable in accordance with the embodiments of the present invention. Thus, although specific mention has been made herethroughout with reference to liquid laundry detergent, it should be appreciated that a wide variety of other viscous liquids, for a wide variety of conceivable uses, can conceivably be employed within the scope of the embodiments of the present invention.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An apparatus for dispensing liquid, said apparatus comprising:
a tubing unit integrable with a container of liquid;
said tubing unit comprising:
a connection arrangement for connecting with a container of liquid;
tubing extending from said connection arrangement; and
a spigot arrangement disposed at an end of said tubing;
said tubing being at least sufficiently translucent as to permit visualization of liquid disposed therewithin;
said tubing comprising at least one marking for facilitating measurement of liquid within said tubing.

2. The apparatus according to claim 1, wherein the liquid is a viscious liquid.

3. The apparatus according to claim 2, wherein the liquid is a liquid laundry detergent.

4. The apparatus according to claim 1, wherein said spigot is configured for selectably actuating and shutting off liquid throughput.

5. The apparatus according to claim 1, wherein said connection arrangement is configured for selectably actuating and shutting off liquid throughput.

6. The apparatus according to claim 1, wherein said connection arrangement and said spigot are configured for trapping a measureable quantity of liquid therebetween in said tubing.

7. An apparatus for dispensing liquid, said apparatus comprising:
a container of liquid; and
a tubing unit extending from said container of liquid;
said tubing unit comprising:
a connection region where said tubing unit is connected with a container of liquid;
tubing extending from said connection region; and
a spigot arrangement disposed at an end of said tubing;
said tubing being at least sufficiently translucent as to permit visualization of liquid disposed therewithin;
said tubing comprising at least one marking for facilitating measurement of liquid within said tubing.

8. A method of for dispensing liquid, said method comprising the steps of:
providing a tubing unit which extends from a connection region at a container of liquid;
said step of providing a tubing unit comprising providing tubing and a spigot arrangement disposed at an end of the tubing, the tubing being at least sufficiently translucent as to permit visualization of liquid disposed therewithin and comprising at least one marking for facilitating measurement of liquid within said tubing;
trapping a measureable quantity of liquid between the connection region and the spigot arrangement in the tubing; and
thereafter dispensing liquid from the spigot arrangement.
